(19) United States
(12) Patent Application Publication
(10) Pub. No.: US 2018/0326348 A1
(43) Pub. Date: Nov. 15, 2018

(54) METHODS AND APPARATUSES FOR GAS SEPARATION BY SOLVENT OR ABSORBENT

(71) Applicant: UOP LLC, Des Plains, IL (US)

(72) Inventors: Nikunj Tanna, Kuala Lumpur (MY); Xiaoming Wen, Palatine, IL (US); Lubo Zhou, Inverness, IL (US)

(21) Appl. No.: 16/045,558

(22) Filed: Jul. 25, 2018

Related U.S. Application Data
(63) Continuation of application No. PCT/US2017/030955, filed on May 4, 2017.
(60) Provisional application No. 62/334,958, filed on May 11, 2016.

(51) Int. Cl. B01D 53/14

(52) U.S. Cl. CPC B01D 53/1406; B01D 53/1425; B01D 53/1462; B01D 53/1493; B01D 2252/2025; B01D 2256/16; B01D 2252/20468; B01D 2252/2056; B01D 2256/245; B01D 2256/20; B01D 2252/20442

(57) ABSTRACT

Solvent absorption processes for separating components of an impure feed gas are disclosed. The processes involve two stages of gas purification. The acid gases including hydrogen sulfide, carbon dioxide and other sulfur compounds are simultaneously removed from the feed gas by contact with a physical solvent in two stages. The subject matter disclosed provide improved processes and apparatus to reduce the operating costs of the system.

### CROSS-REFERENCE TO RELATED APPLICATIONS

This application is a Continuation of copending International Application No. PCT/US2017/030955 filed May 4, 2017, which application claims priority from U.S. Provisional Application No. 62/334,958 filed May 11, 2016, now expired, the contents of which cited applications are hereby incorporated by reference in their entirety.

### FIELD

The present invention relates to gas separation methods, for example the separation of contaminants such as carbon dioxide (CO₂), hydrogen sulfide (H₂S) and other sulfur compounds from gas streams containing such contaminants using a solvent absorption process. The present invention specifically relates to a two-stage absorption operation of the solvent absorption process with reduced operating expenses and utility consumption.

### BACKGROUND

The removal of carbon dioxide, hydrogen sulfide and other sulfur compounds from impure gas streams such as natural gas or synthesis gas is desirable, for among other reasons, to prevent damage to equipment, to improve the heating value of the purified gas product and to make the gas product to be suitable as feedstock for downstream processes. Differences in a number of properties between the impurities like hydrogen sulfide, carbon dioxide and the desired gas product can serve as potential bases for gas separations. These differences include solubility, acidity in aqueous solution, and molecular size and structure. Possible separations can therefore rely on physical or chemical absorption into liquid solvents, pressure swing or temperature swing adsorption with solid adsorbents, and membrane systems.

Liquid solvent based absorption (i.e., “wet”) systems, for example, are commonly used for natural gas and synthesis gas purification to remove hydrogen sulfide, carbon dioxide and other impurities. These contaminants can be preferentially absorbed in physical solvents such as dimethylethers of polyethylene glycol or chemical solvents such as alkanolamines or alkali metal salts. The resulting hydrogen sulfide and CO₂-rich (i.e., “loaded”) solvent is subsequently regenerated by heating to recover the contaminants such as hydrogen sulfide, carbon dioxide and produce a regenerated solvent that can be recycled for further re-use in the absorption process. Solvent regeneration is also normally conducted at a reduced pressure relative to the upstream absorption pressure to promote vaporization of absorbed carbon dioxide from the solvent. The carbon dioxide and hydrogen sulfide may be recovered in more than one stream, including vapor fractions of flash separators and regenerator column vapor effluents.

Chemical solvents, and particularly amines and other basic compounds, react with acidic contaminants such as hydrogen sulfide and carbon dioxide, to form a contaminant-solvent chemical bond. Considerable energy release is associated with this bond formation during the thermodynamically-favored acid-base reaction. Consequently, substantial heat input is required to break the bonds of the chemical reaction products and therefore to regenerate chemical solvents. Physical solvents, on the other hand, do not react chemically with gas contaminants, but instead promote physical absorption based on a higher contaminant equilibrium solubility at its partial pressure in the impure gas (i.e., a higher Henry's law constant).

Physical solvents that remain chemically non-reactive with the contaminant components find wide applications in absorption systems for gas separation. The Selexol process, which is licensed by Honeywell UOP, Des Plaines, Ill., is a process known for removal of carbon dioxide, hydrogen sulfide and other sulfur compounds such as carbonyl sulfide (COS) and mercaptans from feed streams such as syngas produced by gasification of coal, coke or heavy hydrocarbon oils by using a particular physical solvent. Such processes can also be used for removal of ammonia, hydrogen cyanide, and metal carbonyls. The solvent circulation in a Selexol process is usually high compared to a chemical solvent such as an amine. The high solvent circulation could require high regeneration heat input in such cases and may lead to increases in operating cost.

There is a need for an improved process and apparatus for the removal of acid gases from feed streams using a solvent. Further, to address the problems of high utility consumption and increased operating costs, there is a need for a new process and apparatus to efficiently operate the processing unit with reduced solvent circulation rates and reduced utility consumption.

### SUMMARY

An embodiment of the subject matter is a process for a two-stage gas purification comprising contacting an impure feed gas stream comprising hydrogen sulfide (H₂S), carbon dioxide (CO₂) and other sulfur compounds and a solvent stream in a counter-current absorber to provide a first overhead gas stream and a first solvent effluent bottom stream comprising absorbed hydrogen sulfide, absorbed carbon dioxide and absorbed sulfur compounds. The first solvent effluent bottom stream is contacted with an inert gas stream in a counter-current stripper to provide a second overhead gas stream and a second solvent effluent bottom stream. A first portion of the second solvent effluent bottom stream is recycled to a top of a first stage of the counter-current absorber. A second portion of the second solvent effluent bottom stream is passed to a regenerator to provide a third overhead gas stream and a third solvent effluent bottom stream. The third solvent effluent stream is recycled to a top of a second stage of the counter-current absorber. A purified product gas stream is recovered at the overhead of the counter-current absorber.

Another embodiment of the subject matter is a process for a two-stage gas purification process comprising contacting an impure feed gas stream comprising hydrogen sulfide, carbon dioxide and other sulfur compounds and a solvent stream in a counter-current absorber to provide a first overhead gas stream and a first solvent effluent bottom stream comprising absorbed hydrogen sulfide and absorbed carbon dioxide. The first solvent effluent bottom stream is passed to a low pressure flash drum to provide a second overhead gas stream and a second solvent effluent bottom stream. A first portion of the second solvent effluent stream is recycled to a top of a first stage of the counter-current absorber. A second portion of the second solvent effluent bottom stream is passed to a regenerator to provide a third overhead gas stream and a third solvent effluent bottom stream. The third solvent effluent bottom stream is recycled to a top of a second stage of the counter-current absorber. A purified product gas stream is recovered at an overhead of the counter-current absorber.

It is an advantage of the subject matter to provide a novel process and apparatus to remove the acid gases from hydrocarbons with reduced amount of solvent. The present subject matter seeks to provide improved processes and apparatuses to address the problems of high utility consumption and increased operating costs.

Additional objects, advantages and novel features of the examples will be set forth in part in the description which follows, and in part will become apparent to those skilled in the art upon examination of the following description or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

FIG. 1 is a flow scheme for the process and apparatus of the present disclosure.

FIG. 2 is an alternative embodiment for the process and apparatus of the present disclosure. Corresponding reference characters indicate corresponding components throughout the drawings. Skilled artisans will appreciate that elements in the Figures are illustrated for simplicity and clarity and have not necessarily been drawn to scale. For example, the dimensions of some of the elements in the Figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

The following description is not to be taken in a limiting sense, but is made merely for the purpose of describing the general principles of exemplary aspects. The scope of the present disclosure should be determined with reference to the claims.

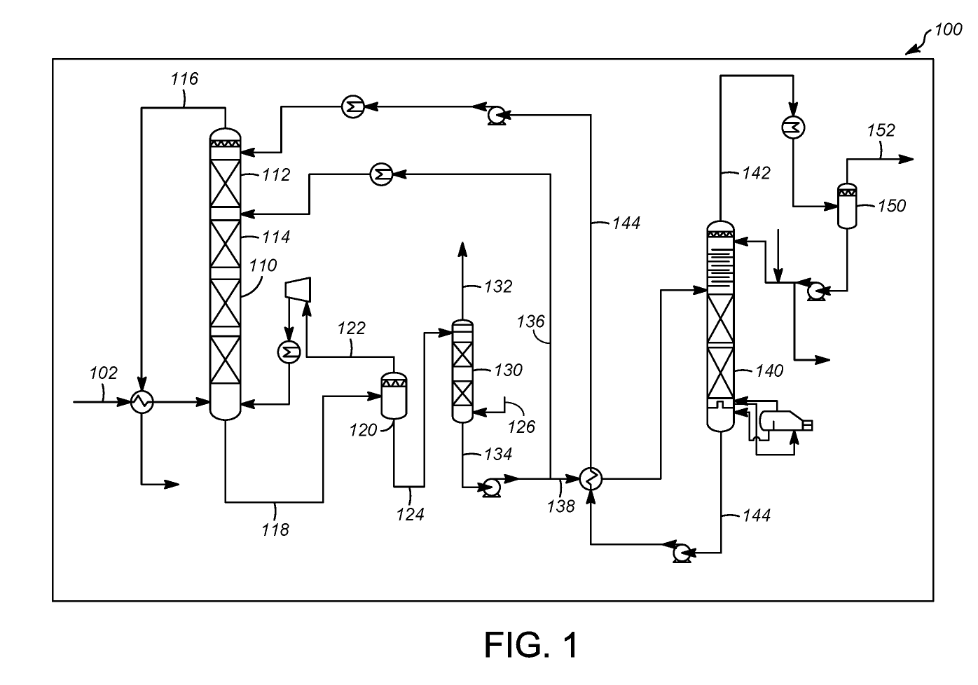

A general understanding of the process for a two-stage gas purification in which a contaminant, present as a component of an impure feed gas, is selectively absorbed into a solvent can be obtained by reference to FIG. 1. The process advantageously recovers significant portions of the desired components in the impure feed gas components, as a purified product gas stream. FIG. 1 has been simplified by the deletion of a large number of apparatuses customarily employed in a process of this nature, such as vessel internals, feed gas knockout drum, product gas wash and knockout drum, solvent filtration system, temperature and pressure controls systems, flow control valves, recycle pumps, etc. which are not specifically required to illustrate the performance of the subject matter. Furthermore, the illustration of the process of this subject matter in the embodiment of a specific drawing is not intended to limit the subject matter to specific embodiments set out herein.

The present subject matter, as shown in FIG. 1, includes an absorption system 100 for a process of a two-stage gas purification involving selective absorption of the contaminants to a solvent. Many configurations of the present invention are possible, but specific embodiments are presented herein by way of example. A feed in line 102 is passed to the absorption system 100. Representative impure gas streams include those comprising light hydrocarbons (e.g., C₁-C₃ hydrocarbons) or hydrogen, or hydrogen and carbon monoxide (CO), with contaminants such as carbon dioxide (CO₂) and hydrogen sulfide (H₂S). Examples of such gas streams comprising acid gas contaminants include natural gas, synthesis gas, refinery flue gas and biogas. The acid gas concentration of the feed stream may be as high as 70%. The process is directed to purification of impure gas feed stream in which a contaminants preferentially absorbed into a liquid solvent, and particularly a physical solvent.

The absorption system 100 comprises a counter-current absorber 110, a rich flash drum 120, a counter-current stripper 130 and a regenerator 140. The feed stream comprising acid gases in line 102 is passed to the counter-current absorber 110 of the absorption system. A gas purification method according to an exemplary embodiment therefore comprises contacting the impure feed gas comprising hydrogen sulfide, carbon dioxide and other sulfur compounds with a solvent, and particularly a physical solvent that selectively (or preferentially) absorbs the acid gases. The impure feed gas stream in line 102 is subjected to contact with a solvent stream in the counter-current absorber 110 to provide a first overhead gas stream in line 116 and a first solvent effluent bottom stream comprising absorbed hydrogen sulfide, absorbed carbon dioxide and absorbed other sulfur compounds in line 118. The operating conditions for the counter-current absorber will include an operating temperature as low as 4° C. and a pressure in the range of about 2700 kPa to about 10000 kPa. Representative physical solvents include alcohols, glycol ethers, lactams, sulfolane, N-alkylated pyrrolidones, N-alkylated piperidines, cyclotetramethylenesulfone, N-alkyformamides, N-alkylacetamides, ether-ketones, propylene carbonate, N-methyl-2-pyrrolidone, N-formyl morpholine, and alkyl phosphates. Others include alkyl- and alkanol-substituted heterocyclic hydrocarbons such as alkanolpyridines (e.g., 3-(pyridin-4-yl)-propan-1-ol) and alkylpyrrolidones (e.g., n-methyl pyrrolidone), as well as dialkylethers of polyethylene glycol, with dimethyl ethers of polyethylene glycol being a preferred physical solvent.

The first solvent effluent bottoms stream in line 118 may be passed to the rich flash drum 120. The gas taken at the overhead of the rich flash drum in line 122 may be compressed and recycled to the counter-current absorber 110 to improve the recovery of the desired components contained in the feed gas stream and the purity of the acid gas in line 152. The effluent bottom stream in line 124 from the rich flash drum 120 is passed to the counter-current stripper 130. The counter-current stripper 130 is in downstream communication with the counter-current absorber 110 and the rich flash drum 120. The operating conditions for the counter-current stripper is maintained at a temperature as low as 4° C. and a pressure of less than about 4100 kPa. The effluent bottom stream in line 124 from the rich flash drum is contacted with an inert gas stream in line 126 in the counter-current stripper 130 to provide a second overhead gas stream in line 132 and a second solvent effluent bottoms stream in line 134. The second overhead gas stream in line 132 comprises mainly carbon dioxide and the inert gas. The inert gas stream in line 126 may be nitrogen. The range of molar ratio of the solvent effluent bottom stream in line 124 to the inert gas stream in line 126 may be about 0.5 to about 10 and preferably in a range of about 0.9 to about 6.

The second solvent effluent bottoms stream in line 134 from the counter-current stripper 130 is split into two portions, a first portion of the second solvent effluent in line 136 and a second portion of the second solvent effluent in line 138. The second solvent effluent bottom stream in line 134 is a semi-lean solvent. The range of molar ratio of the first portion of the second solvent bottoms effluent stream in line 136 to the second portion of the second solvent bottom effluent stream in line 138 may be about 0.1:1 to about 10:1 and preferably in the range of about 0.2:1 to about 5:1.

The first portion of the second solvent effluent bottoms stream in line 136 is recycled to a top of a first stage 114 of the counter-current absorber 110. The first portion of the second solvent effluent bottom stream in line 136 may be chilled and recycled to the first stage of the counter-current absorber. The first stage of the counter-current absorber is a bulk acid gas removal section. The second portion of the second solvent effluent bottoms stream in line 138 is passed to the regenerator 140 to provide a third overhead gas stream in line 142 and a third solvent effluent bottoms stream in line 144. The regenerator is in downstream communication with the counter-current stripper 130. The third solvent effluent stream in line 144 is a lean solvent. The operating condition for the regenerator is maintained at a pressure in the range from about 30 kPa to about 500 kPa, preferably between 80 to 150 kPa. The regenerator 140 is operated at higher temperature than the counter-current absorber 110.

The second overhead gas in line 132 from the counter-current stripper 130 may be contacted counter currently with a portion of the third solvent effluent stream in line 144 or a portion of the first portion of the second solvent effluent in line 136 in a counter-current re-absorber downstream of the counter-current stripper to reduce the sulfur content of the stripped gas. The second overhead gas in line 132 may also be mixed with the acid gas in line 152. The third solvent effluent stream in line 144 is recycled to a top of a second stage 112 of the counter-current absorber 110. A heat exchanger may be used to heat the semi lean solvent in line 138 up by cooling the lean solvent in line 144 down. A chiller may be used to further cool the temperature of the lean solvent in line 144 if lower temperature operation is required and this reduces the solvent circulation rate. According to the present invention, by the use of the two stage absorption and the semi-lean solvent 136, the reboiler duty of the regenerator may be reduced in the range from about 50% to about 80%.

The second stage 112 of the counter-current absorber is downstream from the first stage 114 of the counter-current absorber in the path of the gas stream being purified. The position of the first portion of the second solvent effluent bottom stream in line 136 going into the counter-current absorber 110 may be determined based on the acid gas concentration profile inside the absorber. The third overhead gas stream in line 142 from the regenerator may be passed to a reflux drum 150. The acid gas contaminants are recovered at the overhead of the reflux drum 150 in line 152. The total carbon dioxide (CO₂) removed from the feed gas stream as acid gas in line 152 and as stripped gas in line 132 may be from 0% to about 99.9% and the total amount of hydrogen sulfide (H₂S) removed as acid gas in line 152 and as stripped gas in line 132 may be more than about 99.9%. The total amount of carbonyl sulfide (COS) removed as acid gas in line 152 and as stripped gas in line 132 may be more than about 99%. A purified product gas stream is recovered at the overhead of the counter-current absorber 110 in line 116. The amount of carbon dioxide in the purified product gas stream in line 116 may be less than about 50 ppm-v or higher as required and the amount of the total sulfur content in the purified product gas stream in line 116 may be less than about 0.1 ppm-v or higher as required.

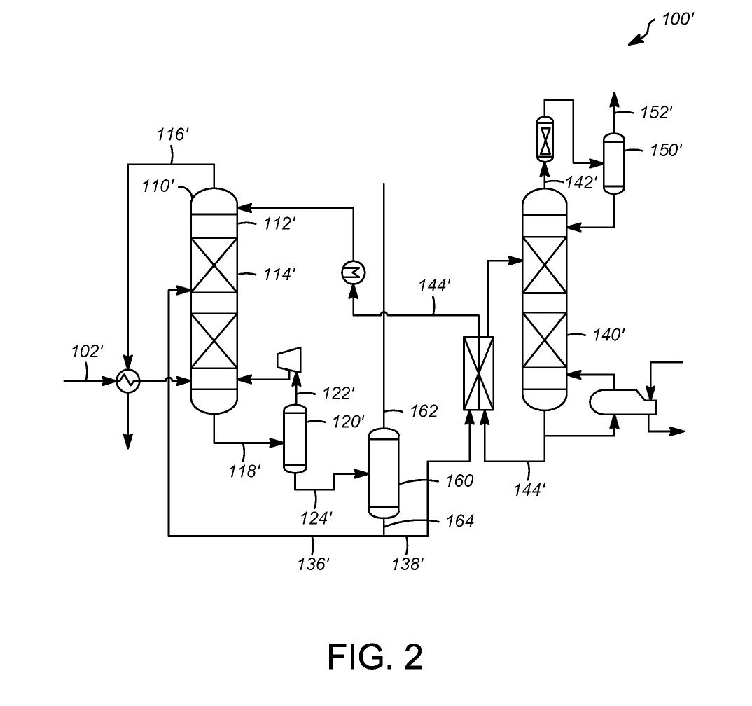

Turning now to FIG. 2, alternative embodiment of the process of the present subject matter shown in FIG. 1 for a two-stage gas purification in which a contaminant, present as a component of an impure feed gas, is selectively absorbed into a solvent. The embodiment of FIG. 2 differs from the embodiment of FIG. 1 in passing the liquid effluent from a high pressure flash drum to a lower pressure flash drum. The similar components in FIG. 2 that were described above for FIG. 1 will not be described again for FIG. 2. Many of the elements in FIG. 2 have the same configuration as in FIG. 1 and bear the same reference number. Elements in FIG. 2 that correspond to elements in FIG. 1 but have a different configuration bear the same reference numeral as in FIG. 1 but are marked with a prime symbol (′).

The present subject matter, as shown in FIG. 2, includes an absorption system 100′ for a process of a two-stage gas purification involving selective absorption of the contaminants to a solvent. Many configurations of the present invention are possible, but specific embodiments are presented herein by way of example. A feed in line 102′ is passed to the absorption system 100′. Representative impure gas streams include those comprising light hydrocarbons (e.g., C₁-C₃ hydrocarbons), or hydrogen, or hydrogen and carbon monoxide (CO), with contaminants, such as carbon dioxide (CO₂) and hydrogen sulfide (H₂S). The examples of such gas streams comprising acid gas contaminants include natural gas, synthesis gas, refinery flue gas or biogas. The acid gas concentration of the feed stream may be as high as 70%. The process is directed to purification of impure gas feed stream in which a contaminant is preferentially absorbed into a liquid solvent, and particularly a physical solvent.

Representative embodiments of the invention are therefore directed to gas purification methods involving two contacting stages. The absorption system 100′ comprises a counter-current absorber 110′, a high pressure flash drum 120′, a low pressure flash drum 160 and a regenerator 140′. The feed stream comprising acid gases in line 102′ is passed to the counter-current absorber 110′ of the absorption system. A gas purification method according to an exemplary embodiment therefore comprises contacting the impure feed gas comprising hydrogen sulfide (H₂S), carbon dioxide (CO₂) and other sulfur compounds with a solvent, and particularly a physical solvent that selectively (or preferentially) absorbs the acid gases. The impure feed gas stream in line 102′ is contacted with a solvent stream in the counter-current absorber 110′ to provide a first overhead gas stream in line 116′ and a first solvent effluent bottom stream comprising absorbed hydrogen sulfide, absorbed carbon dioxide and absorbed other sulfur compounds in line 118′. The operating conditions for the counter-current absorber will include an operating temperature as low as 4° C. and a pressure in the range of about 2700 kPa to about 10000 kPa. Representative physical solvents include alcohols, glycol ethers, lactams, sulfolane, N-alkylated pyrrolidones, N-alkylated piperidines, cyclotetramethylenesulfone, N-alkyformamides, N-alkylacetamides, ether-ketones, propylene carbonate, N-methyl-2-pyrrolidone, N-formyl morpholine, and alkyl phosphates. Others include alkyl- and alkanol-substituted heterocyclic hydrocarbons such as alkanolpyridines (e.g., 3-(pyridin-4-yl)-propan-1-ol) and alkylpyrrolidones (e.g., n-methyl pyrrolidone), as well as dialkylethers of polyethylene glycol, with dimethyl ethers of polyethylene glycol being a preferred physical solvent.

The first solvent effluent bottom stream in line 118′ from the counter-current absorber 110′ is passed to the low pressure flash drum 160. The low pressure flash drum 160 is in downstream communication with the counter-current absorber 110′. The first solvent effluent bottom stream in line 118′ is partially regenerated in the low pressure flash drum 160. An overhead gas stream is taken in line 162 and a second solvent effluent bottom stream in line 164. The second overhead gas stream in line 162 comprises mainly carbon dioxide. The first solvent effluent bottom stream in line 118′ may be passed to the high pressure flash drum 120′ upstream of the low pressure flash drum 160. The first solvent effluent bottom stream in line 118′ may be passed to one or more high pressure flash drums upstream of the low pressure flash drum. The gas taken at the overhead of the high pressure flash drum in line 122′ may be compressed and recycled to the counter-current absorber 110′ to improve recovery of the desired components contained in the feed gas stream and the purity of the acid gas in line 152′. The operating conditions for the low pressure flash drum is maintained at a pressure in the range from about 30 kPa to about 3000 kPa, depending on the acid gas concentration in and the pressure of the feed stream. The second solvent effluent bottoms stream in line 164 from the low pressure flash drum is split into two portions, a first portion of the second solvent effluent in line 136′ and a second portion of the second solvent effluent in line 138′. The second solvent effluent bottoms stream in line 164 is a semi-lean solvent. The range of molar ratio of the first portion of the second solvent bottoms effluent stream in line 136′ to the second portion of the second solvent bottoms effluent stream in line 138′ may be about 0.1:1 to about 10:1 and preferably in the range of about 0.2:1 to about 5:1.

The first portion of the second solvent effluent bottoms stream in line 136′ is recycled to a top of a first stage 114′ of the counter-current absorber 110′. The first portion of the second solvent effluent bottoms stream in line 136′ may be chilled and then recycled to the first stage of the counter-current absorber. The first stage of the counter-current absorber is a bulk acid gas removal section. The second portion of the second solvent effluent bottoms stream in line 138′ is passed to the regenerator 140′ to provide a third overhead gas stream in line 142′ and a third solvent effluent bottoms stream in line 144′. The regenerator is in downstream communication with the low pressure flash drum 160. The third solvent effluent stream in line 144′ is a lean solvent. The operating condition for the regenerator is maintained at a pressure in the range from about 30 kPa to about 500 kPa. The regenerator 140′ is operated at higher temperature than the counter-current absorber 110′.

The third solvent effluent stream in line 144′ is recycled to a top of a second stage 112′ of the counter-current absorber 110′. A heat exchanger may be used to heat the semi-lean solvent in line 138′ up by cooling the lean solvent in line 144′ down. A chiller may be used to further cool the temperature of the lean solvent in line 144′ if lower temperature operation is required and this reduces the solvent circulation rate. According to the present invention, by the use of the two stage absorption and the semi-lean solvent 136′, the reboiler duty of the regenerator may be reduced in the range from about 30% to about 80%.

The second stage 112′ of the counter-current absorber is downstream from the first stage 114′ of the counter-current absorber in the path of the gas stream being purified. The position of the first portion of the second solvent effluent bottoms stream in line 136′ going into the counter-current absorber 110′ may be determined based on the acid gas concentration profile inside the absorber. The third overhead gas stream in line 142′ from the regenerator may be passed to a reflux drum 150′. The acid gas contaminants are recovered at the overhead of the reflux drum 150′ in line 152′. The total CO₂ removed from the feed gas stream in line 152′ may be from 0% to about 99.9% and the total amount of H₂S removed in line 152′ may be more than about 99.9%. The total amount of carbonyl sulfide removed in line 152′ may be more than about 99%. A purified product gas stream is recovered at the overhead of the counter-current absorber 110′ in line 116′. The amount of carbon dioxide in the purified product gas stream in line 116′ may be less than about 50 ppm-v or more as required and the amount of the total sulfur content in the purified product gas stream in line 116′ may be less than about 0.1 ppm-v or more as required.

Overall, aspects of the invention are associated with processes for purifying impure feed gas streams which advantageously allow the recovery of the desired components from these feed gas streams at high purity. The processes comprise contacting the impure feed gas with a semi-lean solvent and lean solvent in a two-stage absorber. An exemplary impure feed gas stream is predominantly a gas stream comprising hydrogen sulfide (H₂S), carbon dioxide and other sulfur compounds as impurities or contaminants. Those having skill in the art will recognize the applicability of the methods disclosed herein to any of a number of gas purification processes, and particularly those utilizing a physical solvent that preferentially absorbs the contaminants.

While the subject matter has been described with what are presently considered the preferred embodiments, it is to be understood that the subject matter is not limited to the disclosed embodiments, but it is intended to cover various modifications and equivalent arrangements included within the scope of the appended claims.

### Specific Embodiments

While the following is described in conjunction with specific embodiments, it will be understood that this description is intended to illustrate and not limit the scope of the preceding description and the appended claims.

A first embodiment of the subject matter is a process for a two-stage gas purification comprising contacting an impure feed gas stream comprising hydrogen sulfide (H₂S), carbon dioxide (CO₂) and other sulfur compounds and a solvent stream in a counter-current absorber to provide a first overhead gas stream and a first solvent effluent bottoms stream comprising absorbed hydrogen sulfide, absorbed carbon dioxide and absorbed sulfur compounds; contacting the first solvent effluent bottoms stream with an inert gas stream in a counter-current stripper to provide a second overhead gas stream and a second solvent effluent bottoms stream; recycling a first portion of the second solvent effluent bottoms stream to a top of a first stage of the counter current absorber; passing a second portion of the second solvent effluent bottoms stream to a regenerator to provide a third overhead gas stream and a third solvent effluent bottoms stream; recycling the third solvent effluent stream to a top of a second stage of the counter-current absorber; and recovering a purified product gas stream at the overhead of the counter-current absorber. An embodiment of the invention is one, any or all of prior embodiments in this paragraph up through the first embodiment in this paragraph wherein the second overhead gas stream comprises carbon dioxide. An embodiment of the invention is one, any or all of prior embodiments in this paragraph up through the first embodiment in this paragraph wherein the second stage of the counter-current absorber is downstream from the first stage of the counter-current absorber in the path of the gas stream being purified. An embodiment of the invention is one, any or all of prior embodiments in this paragraph up through the first embodiment in this paragraph wherein the molar ratio of the first solvent effluent bottoms stream that is sent to the counter-current stripper to the inert gas stream is about 0.5 to 10. An embodiment of the invention is one, any or all of prior embodiments in this paragraph up through the first embodiment in this paragraph wherein the inert gas stream is nitrogen. An embodiment of the invention is one, any or all of prior embodiments in this paragraph up through the first embodiment in this paragraph wherein the solvent is selected from group consisting of alcohols, glycol ethers, lactams, sulfolane, N-alkylated pyrrolidones, N-alkylated piperidines, cyclotetramethylenesulfone, N-alkyformamides, N-alkylacetamides, ether-ketones, propylene carbonate, N-methyl-2-pyrrolidone, N-formyl morpholine, and alkyl phosphates. An embodiment of the invention is one, any or all of prior embodiments in this paragraph up through the first embodiment in this paragraph further comprising contacting the second overhead gas from the counter-current stripper with the third solvent effluent stream or the first portion of the second solvent effluent in a counter-current re-absorber downstream of the counter-current stripper. An embodiment of the invention is one, any or all of prior embodiments in this paragraph up through the first embodiment in this paragraph wherein the range of molar ratio of the first portion of the second solvent bottoms effluent stream to the second portion of the second solvent bottoms effluent stream is about 0.1:1 to about 10:1. An embodiment of the invention is one, any or all of prior embodiments in this paragraph up through the first embodiment in this paragraph wherein the amount of carbon dioxide in the purified product stream is less than about 50 ppm-v and the amount of the total sulfur content in the purified product stream is less than about 0.1 ppm-v. An embodiment of the invention is one, any or all of prior embodiments in this paragraph up through the first embodiment in this paragraph further comprising passing the first solvent effluent bottoms stream to a rich flash drum upstream of the counter-current stripper. An embodiment of the invention is one, any or all of prior embodiments in this paragraph up through the first embodiment in this paragraph wherein the counter-current absorber is maintained at a pressure from about 2700 kPa to about 10000 kPa. An embodiment of the invention is one, any or all of prior embodiments in this paragraph up through the first embodiment in this paragraph wherein the counter-current stripper is maintained at a pressure less than about 4100 kPa. An embodiment of the invention is one, any or all of prior embodiments in this paragraph up through the first embodiment in this paragraph wherein the regenerator is maintained at a pressure from about 30 kPa to about 500 kPa.

A second embodiment of the invention is process for a two-stage gas purification process comprising contacting an impure feed gas stream comprising hydrogen sulfide, carbon dioxide and other sulfur compounds and a solvent stream in a counter-current absorber to provide a first overhead gas stream and a first solvent effluent bottoms stream comprising absorbed hydrogen sulfide and absorbed carbon dioxide; passing the first solvent effluent bottoms stream to a low pressure flash drum to provide a second overhead gas stream and a second solvent effluent bottoms stream; recycling a first portion of the second solvent effluent stream to a top of a first stage of the counter-current absorber; passing a second portion of the second solvent effluent bottoms stream to a regenerator to provide a third overhead gas stream and a third solvent effluent bottoms stream; recycling the third solvent effluent bottoms stream to a top of a second stage of the counter-current absorber; and recovering a purified product gas stream at an overhead of the counter-current absorber. An embodiment of the invention is one, any or all of prior embodiments in this paragraph up through the second embodiment in this paragraph wherein the pressure of the low pressure flash drum is in the range from about 30 kPa to about 3000 kPa. An embodiment of the invention is one, any or all of prior embodiments in this paragraph up through the second embodiment in this paragraph wherein the range of molar ratio of the first portion of the second solvent effluent bottoms stream to the second portion of the second solvent effluent bottoms stream is about 0.1:1 to about 10:1. An embodiment of the invention is one, any or all of prior embodiments in this paragraph up through the second embodiment in this paragraph wherein the amount of carbon dioxide in the purified product stream is less than about 50 ppm-v. An embodiment of the invention is one, any or all of prior embodiments in this paragraph up through the second embodiment in this paragraph wherein the amount of total sulfur content in the purified product stream is less than about 0.1 ppm-v. An embodiment of the invention is one, any or all of prior embodiments in this paragraph up through the second embodiment in this paragraph wherein the solvent is selected from group consisting of alcohols, glycol ethers, lactams, sulfolane, N-alkylated pyrrolidones, N-alkylated piperidines, cyclotetramethylenesulfone, N-alkyformamides, N-alkylacetamides, ether-ketones, propylene carbonate, N-methyl-2-pyrrolidone, N-formyl morpholine or alkyl phosphates. An embodiment of the invention is one, any or all of prior embodiments in this paragraph up through the second embodiment in this paragraph further comprising passing the first solvent effluent bottoms stream to one or more higher pressure flash drum upstream of the low pressure flash drum.

Without further elaboration, it is believed that using the preceding description that one skilled in the art can utilize the present subject matter to its fullest extent and easily ascertain the essential characteristics of this subject matter, without departing from the spirit and scope thereof, to make various changes and modifications of the subject matter and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

1. A two-stage gas purification process comprising:
contacting an impure feed gas stream comprising hydrogen sulfide, carbon dioxide and sulfur compounds and a solvent stream in a counter-current absorber to provide a first overhead gas stream and a first solvent effluent bottoms stream comprising absorbed hydrogen sulfide, absorbed carbon dioxide and absorbed other sulfur compounds;
contacting the first solvent effluent bottoms stream with an inert gas stream in a counter-current stripper to provide a second overhead gas stream and a second solvent effluent bottoms stream;
recycling a first portion of the second solvent effluent bottoms stream to a top of a first stage of the counter current absorber;
passing a second portion of the second solvent effluent bottoms stream to a regenerator to provide a third overhead gas stream and a third solvent effluent bottoms stream;
recycling the third solvent effluent stream to a top of a second stage of the counter-current absorber; and
recovering a purified product gas stream at the overhead of the counter-current absorber.

2. The two-stage gas purification process of claim 1, wherein the second overhead gas stream comprises carbon dioxide.

3. The two-stage gas purification process of claim 1, wherein the second stage of the counter-current absorber is downstream from the first stage of the counter-current absorber in the path of the gas stream being purified.

4. The two-stage gas purification process of claim 1, wherein the molar ratio of the first solvent effluent bottoms stream that is sent to the counter-current stripper to the inert gas stream is about 0.5 to 10.

5. The two-stage gas purification process of claim 1, wherein the inert gas stream is nitrogen.

6. The two-stage gas purification process of claim 1, wherein the solvent is selected from group consisting of alcohols, glycol ethers, lactams, sulfolane, N-alkylated pyrrolidones, N-alkylated piperidines, cyclotetramethylenesulfone, N-alkyformamides, N-alkylacetamides, ether-ketones, propylene carbonate, N-methyl-2-pyrrolidone, N-formyl morpholine, and alkyl phosphates.

7. The two-stage gas purification process of claim 1, further comprising contacting the second overhead gas from the counter-current stripper with the third solvent effluent stream or the first portion of the second solvent effluent in a counter-current re-absorber downstream of the counter-current stripper.

8. The two-stage gas purification process of claim 1, wherein the range of molar ratio of the first portion of the second solvent bottoms effluent stream to the second portion of the second solvent bottoms effluent stream is about 0.1:1 to about 10:1.

9. The two-stage gas purification process of claim 1, wherein the amount of carbon dioxide in the purified product stream is less than about 50 ppm-v and the amount of the total sulfur content in the purified product stream is less than about 0.1 ppm-v.

10. The two-stage gas purification process of claim 1, further comprising passing the first solvent effluent bottoms stream to a rich flash drum upstream of the counter-current stripper.

11. The two-stage gas purification process of claim 1, wherein the counter-current absorber is maintained at a pressure from about 2700 kPa to about 10000 kPa.

12. The two-stage gas purification process of claim 1, wherein the counter-current stripper is maintained at a pressure less than about 4100 kPa.

13. The two-stage gas purification process of claim 1, wherein the regenerator is maintained at a pressure from about 30 kPa to about 500 kPa.

14. A two-stage gas purification process comprising:
contacting an impure feed gas stream comprising hydrogen sulfide, carbon dioxide and sulfur compounds and a solvent stream in a counter-current absorber to provide a first overhead gas stream and a first solvent effluent bottoms stream comprising absorbed hydrogen sulfide and absorbed carbon dioxide;
passing the first solvent effluent bottoms stream to a low pressure flash drum to provide a second overhead gas stream and a second solvent effluent bottoms stream;
recycling a first portion of the second solvent effluent stream to a top of a first stage of the counter-current absorber;
passing a second portion of the second solvent effluent bottoms stream to a regenerator to provide a third overhead gas stream and a third solvent effluent bottoms stream;
recycling the third solvent effluent bottoms stream to a top of a second stage of the counter-current absorber; and
recovering a purified product gas stream at an overhead of the counter-current absorber.

15. The two-stage gas purification process of claim 14, wherein the pressure of the low pressure flash drum is in the range from about 30 kPa to about 3000 kPa. 16. The two-stage gas purification process of claim 14, wherein the range of molar ratio of the first portion of the second solvent effluent bottoms stream to the second portion of the second solvent effluent bottoms stream is about 0.1:1 to about 10:1.

16. The two-stage gas purification process of claim 14, wherein the amount of carbon dioxide in the purified product stream is less than about 50 ppm-v.

17. The two-stage gas purification process of claim 14, wherein the amount of total sulfur content in the purified product stream is less than about 0.1 ppm-v.

18. The two-stage gas purification process of claim 14, wherein the solvent is selected from group consisting of alcohols, glycol ethers, lactams, sulfolane, N-alkylated pyrrolidones, N-alkylated piperidines, cyclotetramethylenesulfone, N-alkyformamides, N-alkylacetamides, ether-ketones, propylene carbonate, N-methyl-2-pyrrolidone, N-formyl morpholine or alkyl phosphates.

19. The two-stage gas purification process of claim 14, further comprising passing the first solvent effluent bottoms stream to one or more higher pressure flash drum upstream of the low pressure flash drum.
